(19) United States
(12) Patent Application Publication
(10) Pub. No.: US 2023/0239753 A1
(43) Pub. Date: Jul. 27, 2023

(54) RECONFIGURATION FAILURE HANDLING FOR CPAC

(71) Applicant: NOKIA TECHNOLOGIES OY, Espoo (FI)

(72) Inventors: Srinivasan Selvaganapathy, Bangalore (IN); Jedrzej Stanczak, Wroclaw (PL); Ahmad Awada, Munich (DE)

(21) Appl. No.: 18/158,429

(22) Filed: Jan. 23, 2023

(30) Foreign Application Priority Data
Jan. 25, 2022 (IN) 202241004189

(51) Int. Cl. H04W 36/00; H04W 48/20

(52) U.S. Cl. CPC H04W 36/00837; H04W 36/0061; H04W 48/20

(57) ABSTRACT

There is provided an apparatus comprising means for: receiving, from a network node, at least one conditional primary secondary cell change and addition reconfiguration and at least one execution condition associated with at least one candidate primary secondary cell, wherein the reconfiguration comprises at least a new configuration for a master cell group; evaluating the at least one execution condition; determining that an execution condition associated with one of the at least one candidate primary secondary cell is satisfied; selecting the one of the at least one candidate primary secondary cell as a selected candidate cell; transmitting information on the selected candidate cell to the network node using a current master cell group configuration; failing to apply the conditional primary secondary cell change and addition associated with the selected candidate cell and detecting a reconfiguration failure; transmitting a message to trigger a re-establishment procedure, wherein the message comprises an explicit or implicit indication about the conditional primary secondary cell change and addition reconfiguration failure.

### RELATED APPLICATIONS

This application claims priority to Indian patent application No. 202241004189, filed Jan. 25, 2022, entitled “RECONFIGURATION FAILURE HANDLING FOR CPAC” which is hereby incorporated by reference in its entirety.

### FIELD

Various example embodiments relate to conditional primary secondary cell addition and change (CPAC) procedures.

### BACKGROUND

Conditional primary secondary cell addition and change (CPAC) configuration for execution may include changes in master cell group (MCG) and secondary cell group (MCG) configurations.

### SUMMARY

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus comprising means for: receiving, from a network node, at least one conditional primary secondary cell change and addition reconfiguration and at least one execution condition associated with at least one candidate primary secondary cell, wherein the reconfiguration comprises at least a new configuration for a master cell group; evaluating the at least one execution condition; determining that an execution condition associated with one of the at least one candidate primary secondary cell is satisfied; selecting the one of the at least one candidate primary secondary cell as a selected candidate cell; transmitting information on the selected candidate cell to the network node using a current master cell group configuration; failing to apply the conditional primary secondary cell change and addition associated with the selected candidate cell and detecting a reconfiguration failure; transmitting a message to trigger a re-establishment procedure, wherein the message comprises an explicit or implicit indication about the conditional primary secondary cell change and addition reconfiguration failure.

According to a second aspect, there is provided a network node, comprising means for: transmitting, to a user equipment, at least one conditional primary secondary cell change and addition reconfiguration and at least one execution condition associated with at least one candidate primary secondary cell, wherein the reconfiguration comprises at least a new configuration for a master cell group; receiving, from the user equipment, information on a selected candidate cell which satisfies an execution condition; switching configuration from a current master cell group configuration to the new configuration for the master cell group that is associated with the selected candidate cell; receiving, from the user equipment, a message to trigger a re-establishment procedure, wherein the message comprises an explicit or implicit indication about the conditional primary secondary cell change and addition reconfiguration failure.

According to a third aspect, there is provided a network node, comprising means for: transmitting, to a user equipment, at least one conditional primary secondary cell change and addition reconfiguration and at least one execution condition associated with at least one candidate primary secondary cell, wherein the reconfiguration comprises at least a new configuration for a master cell group; receiving, from the user equipment, information on a selected candidate cell which satisfies an execution condition; switching configuration from a current master cell group configuration to the new configuration for the master cell group that is associated with the selected candidate cell; preserving the current master cell group configuration for a re-establishment procedure.

According to a fourth aspect, there is provided a network node configured to function as a target node in a conditional primary secondary cell change and addition procedure, comprising means for: receiving, from the user equipment, a message to trigger a re-establishment procedure, wherein the message comprises an explicit or implicit indication about the conditional primary secondary cell change and addition reconfiguration failure.

According to a fifth aspect, there is provided a method comprising: receiving, from a network node, at least one conditional primary secondary cell change and addition reconfiguration and at least one execution condition associated with at least one candidate primary secondary cell, wherein the reconfiguration comprises at least a new configuration for a master cell group; evaluating the at least one execution condition; determining that an execution condition associated with one of the at least one candidate primary secondary cell is satisfied; selecting the one of the at least one candidate primary secondary cell as a selected candidate cell; transmitting information on the selected candidate cell to the network node using a current master cell group configuration; failing to apply the conditional primary secondary cell change and addition associated with the selected candidate cell and detecting a reconfiguration failure; transmitting a message to trigger a re-establishment procedure, wherein the message comprises an explicit or implicit indication about the conditional primary secondary cell change and addition reconfiguration failure.

According to a sixth aspect, there is provided a non-transitory computer readable medium comprising program instructions that, when executed by at least one processor, cause an apparatus to at least to perform the method of the fifth aspect and any of the embodiments thereof.

According to a seventh aspect, there is provided computer program configured to cause an apparatus to perform a method of the fifth aspect and any of the embodiments thereof.

According to an eighth aspect, there is provided a method comprising: transmitting, to a user equipment, at least one conditional primary secondary cell change and addition reconfiguration and at least one execution condition associated with at least one candidate primary secondary cell, wherein the reconfiguration comprises at least a new configuration for a master cell group; receiving, from the user equipment, information on a selected candidate cell which satisfies an execution condition; switching configuration from a current master cell group configuration to the new configuration for the master cell group that is associated with the selected candidate cell; receiving, from the user equipment, a message to trigger a re-establishment procedure, wherein the message comprises an explicit or implicit indication about the conditional primary secondary cell change and addition reconfiguration failure.

According to a ninth aspect, there is provided a method comprising: transmitting, to a user equipment, at least one conditional primary secondary cell change and addition reconfiguration and at least one execution condition associated with at least one candidate primary secondary cell, wherein the reconfiguration comprises at least a new configuration for a master cell group; receiving, from the user equipment, information on a selected candidate cell which satisfies an execution condition; switching configuration from a current master cell group configuration to the new configuration for the master cell group that is associated with the selected candidate cell; preserving the current master cell group configuration for a re-establishment procedure.

According to an embodiment, the method comprises: receiving a request from a target node to provide context of the user equipment which has triggered re-establishment procedure; transmitting a response to the target node, the response comprising context of the user equipment corresponding to the current master cell group configuration.

According to a tenth aspect, there is provided a method comprising: receiving by a network node configured to function as a target node in a conditional primary secondary cell change and addition procedure, from the user equipment, a message to trigger a re-establishment procedure, wherein the message comprises an explicit or implicit indication about the conditional primary secondary cell change and addition reconfiguration failure.

According to an embodiment, the method comprises transmitting a request to a master node to provide context of the user equipment which has triggered re-establishment procedure; receiving a response from the master node, the response comprising context of the user equipment corresponding to a current master cell group configuration.

According to further aspects, there is provided there is provided a non-transitory computer readable medium comprising program instructions that, when executed by at least one processor, cause an apparatus to at least to perform the method of any of the eighth, ninth, or tenth aspect and any of the embodiments thereof.

According to further aspects, there is provided computer program configured to cause an apparatus to perform a method of any of the eighth, ninth, or tenth aspect and any of the embodiments thereof.

### BRIEF DESCRIPTION OF THE DRAWINGS

FIG. 1 shows, by way of example, a network architecture of communication system;

FIG. 2 shows, by way of example, signalling diagram for conditional primary secondary cell change;

FIG. 3 shows, by way of example, a flowchart of a method;

FIG. 4a shows, by way of example, a flowchart of a method;

FIG. 4b shows, by way of example, a flowchart of a method;

FIG. 5 shows, by way of example, signalling between entities;

FIG. 6 shows, by way of example, signalling between entities;

FIG. 7 shows, by way of example, a block diagram of an apparatus; and

FIG. 8 shows, by way of example, a flowchart of a method.

### DETAILED DESCRIPTION

In conditional primary secondary cell addition and change (CPAC) execution, a configuration mismatch may occur between a user equipment and a network node causing reconfiguration failure. Methods are provided for handling the reconfiguration failure.

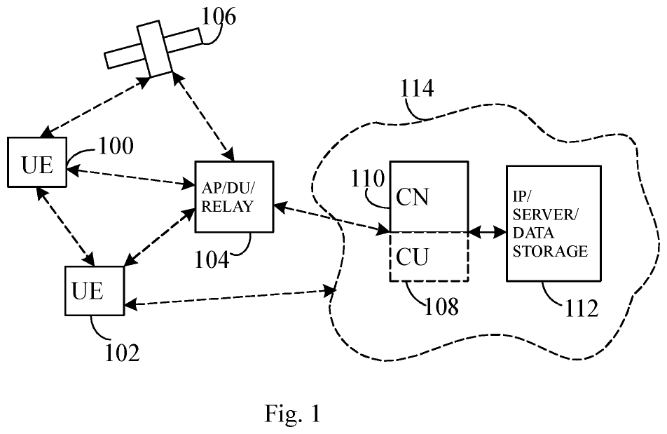

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The example of FIG. 1 shows a part of an exemplifying radio access network. FIG. 1 shows user devices 100 and 102 configured to be in a wireless connection on one or more communication channels in a cell with an access node, such as gNB, i.e., next generation NodeB, or eNB, i.e., evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e., IAB donor, which may have wired connection with the CN, and wireless connection with the IAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units (not all shown in FIG. 1) may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the constellation may cover several satellite-enabled network entities that create on-ground cells. The on-ground cells may be created through an on-ground relay node 104 or by a gNB located on-ground or in a satellite.

Dual connectivity is a mode of operation where UE is allowed to simultaneously transmit and receive data on multiple component carries from two cell groups via master node (MN) and secondary node (SN). A master cell group (MCG) is a group of serving cells associated with the MN. The MCG comprises a primary cell (PCell) and optionally one or more secondary cells (SCells). Secondary cell group (SCG) is a group of service cells associated with the SN, and also comprises a PCell and optionally one or more SCells.

Conditional primary secondary cell change (CPC) and conditional primary secondary cell addition (CPA) may be referred to by a common term conditional primary secondary cell addition and change (CPAC). CPAC configuration for execution may include both MCG and SCG configurations in some scenarios.

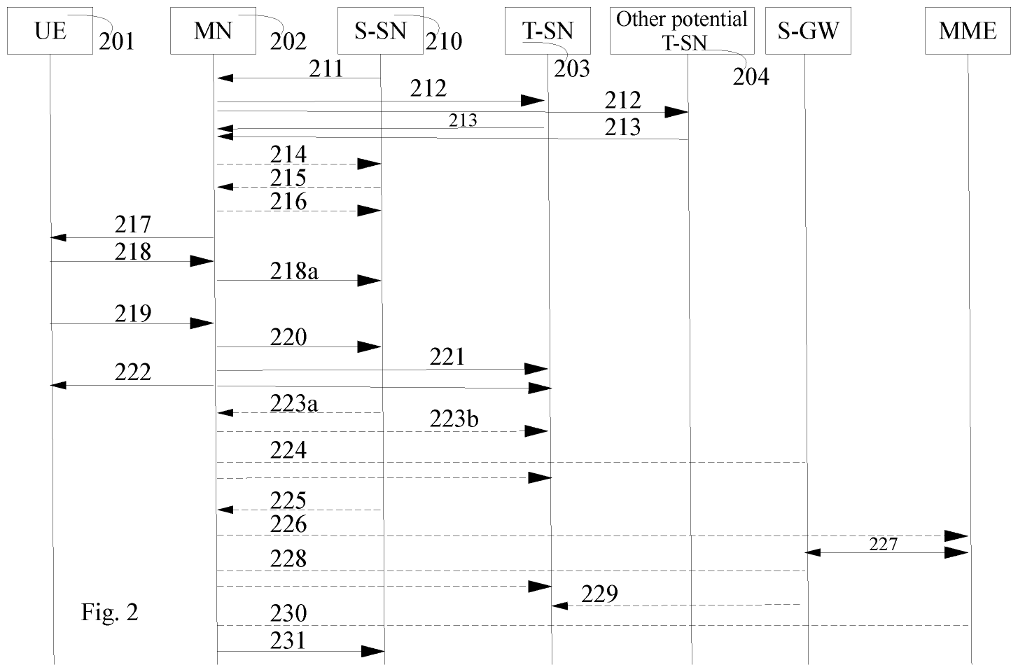

FIG. 2 shows, by way of example, signalling diagram for conditional primary secondary cell change (CPC) initiated by a secondary node (SN). Similar signalling diagram may be used for CPA and CPC initiated by a master node (MN), wherein the procedure is triggered by the MN instead of the SN, and SN change might not be required.

The source SN (S-SN) 210 initiates the conditional SN change procedure by sending 211 SgNB Change Required message which contains a CPC initiation indication. The message may also contain target SN ID information and may include the SCG configuration to support delta configuration. The message may contain the measurement results related to the target candidate SN. The message may include a list of proposed PSCell candidates 203, 204 recommended by the source SN 210, including execution conditions associated with the candidates. The message may include the SCG measurement configurations for CPC, e.g., measurement IDs (measId(s)) to be used for CPC. Measurements may comprise, for example, measurements related to signal quality of the cells.

The MN 202 requests the target candidate SN to allocate resources for the UE 201 by means of the SgNB Addition procedure 212, 213, including a CPC initiation indication, and the measurements results related to the target candidate SN and indicates the list of proposed PSCell candidates received from the source SN. The request might not include execution conditions. Within the list of PSCells, the SN decides the list of PSCell(s) to prepare and, for each prepared PSCell, the SN decides other SCG SCells and provides the new corresponding SCG radio resource configuration to the MN in an NR RRC configuration message (RRCReconfiguration****) contained in the SgNB Addition Request Acknowledge message 213.

If forwarding is needed, the target SN (T-SN) provides forwarding addresses to the MN. The target SN includes the indication of the full or delta RRC configuration, and the list of prepared PSCell IDs to the MN. The target SN can either accept or reject each of the candidate cells suggested by the source SN, i.e., the target SN cannot come up with any alternative candidates.

The MN 202 may indicate 214 the candidate PSCells accepted by the target SN to the source SN, if needed, e.g., when T-SN does not acknowledge all candidate PSCells.

The source SN may provide 215 updated measurement configurations for CPC to the MN.

If early data forwarding is applied, the MN 202 informs 216 the source SN 210 the data forwarding addresses as received from the target SN.

The MN sends 217 to the UE an RRC Connection Reconfiguration message (RRCConnectionReconfiguration*) including the CPC configuration, (i.e., a list of RRC Connection Reconfiguration messages RRCConnectionReconfiguration***) and associated execution conditions, in which RRCConnectionReconfiguration* * * contains RRCReconfiguration**** received from the candidate SN. In addition, the RRC Connection Reconfiguration message (RRCConnectionReconfiguration*) can also include the current MCG updated configuration, e.g., to configure the required conditional measurements, as well as the NR RRC configuration message (RRCReconfigutation**) generated by the source-SN.

The UE 201 applies 218 the RRC configuration (in RRCConnectionReconfiguration*) excluding the CPC configuration, stores the CPC configuration and replies to the MN 202 with an RRC Connection Reconfiguration Complete message (RCConnectionReconfigurationComplete*), which can include an NR RRC response message (RRCReconfigurationComplete**).

In case the UE is unable to comply with at least part of the configuration included in the RRCConnectionReconfiguration* message, it performs the reconfiguration failure procedure.

If an NR RRC response message is included, the MN 202 informs 218a the source SN 210 with the NR RRC response message (RRCReconfigutationComplete**) for the source SN. The MN may indicate the candidate PSCells accepted by the target SN to the source SN.

The UE 201 starts evaluating the execution conditions. If the execution condition of one candidate PSCell is satisfied, the UE 201 applies RRC Connection Reconfiguration message (RRCConnectionReconfiguration***) corresponding to the selected candidate PSCell, and sends 219 an RRC Connection Reconfiguration Complete message (RRCConnectionReconfigurationComplete***) to the MN 202. The message may include an NR RRC message (RRCReconfigurationComplete****) for the selected candidate PSCell. The message may indicate the selected PSCell information to the MN.

The MN 202 informs 220 via SgNB Change Confirm message the source SN 210 to stop providing user data to the UE, and provide the address of the selected target SN and if applicable, start late data forwarding.

If the RRC connection reconfiguration procedure was successful, the MN informs 221 the target SN 203 via SgNB Reconfiguration Complete message, including the SN RRCReconfigurationComplete**** response message for the target SN. The MN cancels CPC in the other target candidate SNs, if configured.

The UE 201 synchronizes 222 via random access procedure to the target SN 203 indicated in RRCConnectionReconfiguration***.

For SN terminated bearers using radio link control (RLC) acknowledge mode (AM), the source SN 210 sends 323a the SN Status Transfer, which the MN 202 sends 323b then to the target SN 203, if needed.

If applicable, data forwarding 224 from the source SN takes place. It may be initiated as early as the source SN receives the early data forwarding message from the MN.

The source SN 210 sends 225 the Secondary radio access technology (RAT) Data Usage Report message to the MN 202 and includes the data volumes delivered to and received from the UE 201 over the NR radio for the related bearers, e.g., E-UTRAN radio access bearers (E-RABs).

If applicable, a path update is triggered 226 (E-RAB modification indication), 227 (bearer modification), 228 (end marker packet), 229 (new path), 230 (E-RAB modification confirm) by the MN 202.

Upon reception 231 of the UE Context Release message from the MN 202, the source SN 210 releases radio and C-plane related resources associated to the UE context. Any ongoing data forwarding may continue.

In a classic SCG change scenario, i.e., not conditional, when UE receives RRC connection reconfiguration comprising MCG and SCG changes, the UE applies the new configuration of MCG and SCG directly after receiving the configuration message. This has been described, for example, in 3GPP TS 37.340, section 10.5.1. Immediate usage of the new configuration is possible in the classic SCG change scenario, because the MN has already applied the new configuration when sending the RRC connection reconfiguration and the MN can then receive the RRC connection reconfiguration complete message using the new configuration.

However, in case of a conditional PScell change and addition, the MN continues to use a current/original/old configuration until CPAC execution occurs, as in step 219 in the example of FIG. 2. In other words, new MCG configuration is applied after the execution condition is met. Thus, in case of a reconfiguration failure, a mismatch may occur between configuration of the UE and configuration of the network. The situation is clarified with an example below.

Let us consider that the UE has evaluated the CPAC execution condition and the CPAC execution condition has been met. UE informs MN about the CPAC execution of a specific CPAC configuration Z with a candidate cell with ID X. MN switches its configuration from current MCG configuration Y to MCG configuration Z included in CPAC configuration associated with ID X. However, it may happen that the UE fails to apply the CPAC configuration and detects an RRC connection reconfiguration failure. UE then reverts back to the original MCG configuration Y. Thus, the MN has already switched to the configuration Z and the UE has preserved the current configuration Y resulting in a mismatch of configurations. UE re-establishes to a target cell controlled by a target node, which fetches the UE context from source node, i.e., the MN. MN returns UE context comprising the MCG configuration Z. The target node reconfigured the UE assuming that the configuration is Z at the UE while the UE actually has the configuration Y. This reconfiguration from the target node most likely leads to a UE detecting RRC connection reconfiguration failure and performing re-establishment.

Methods are provided for handling a reconfiguration failure in CPAC scenario with MCG configuration change.

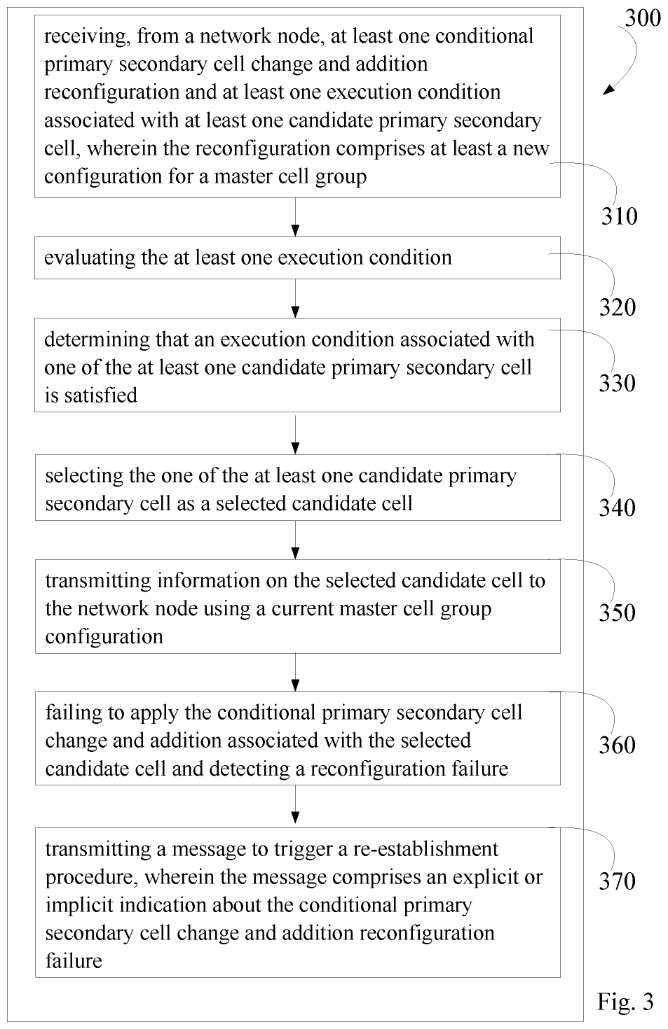

FIG. 3 shows, by way of example, a flowchart of a method 300. The method may be performed by an apparatus, such as a UE. The method 300 comprises receiving 310, from a network node, at least one conditional primary secondary cell change and addition reconfiguration and at least one execution condition associated with at least one candidate primary secondary cell, wherein the reconfiguration comprises at least a new configuration for a master cell group. The method 300 comprises evaluating 320 the at least one execution condition. The method 300 comprises determining 330 that an execution condition associated with one of the at least one candidate primary secondary cell is satisfied. The method 300 comprises selecting 340 the one of the at least one candidate primary secondary cell as a selected candidate cell. The method 300 comprises transmitting 350 information on the selected candidate cell to the network node using a current master cell group configuration. The method 300 comprises failing 360 to apply the conditional primary secondary cell change and addition associated with the selected candidate cell and detecting a reconfiguration failure. The method 300 comprises transmitting 370 a message to trigger a re-establishment procedure, wherein the message comprises an explicit or implicit indication about the conditional primary secondary cell change and addition reconfiguration failure.

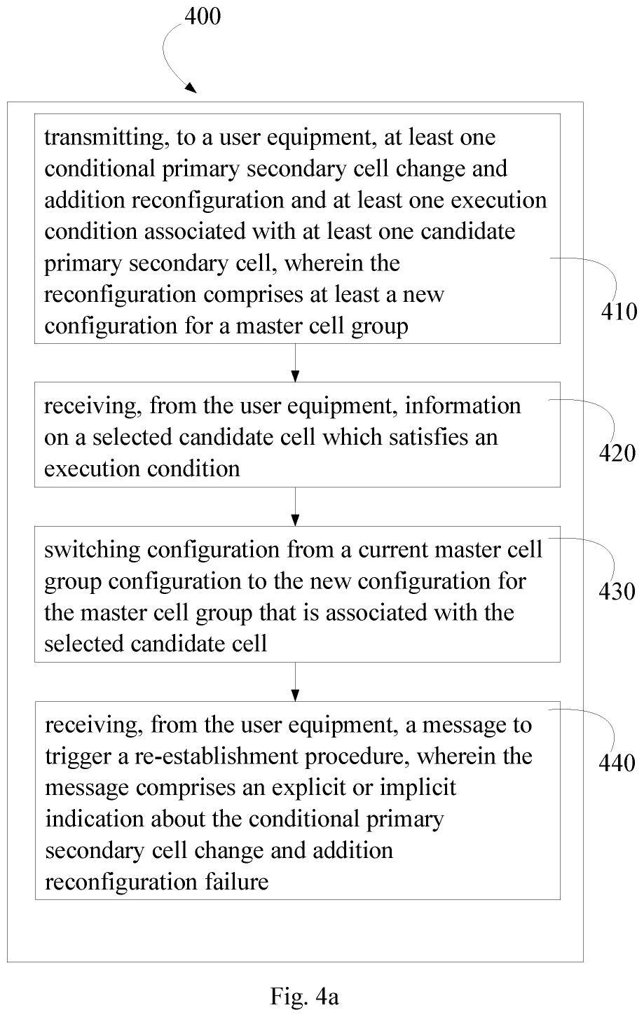

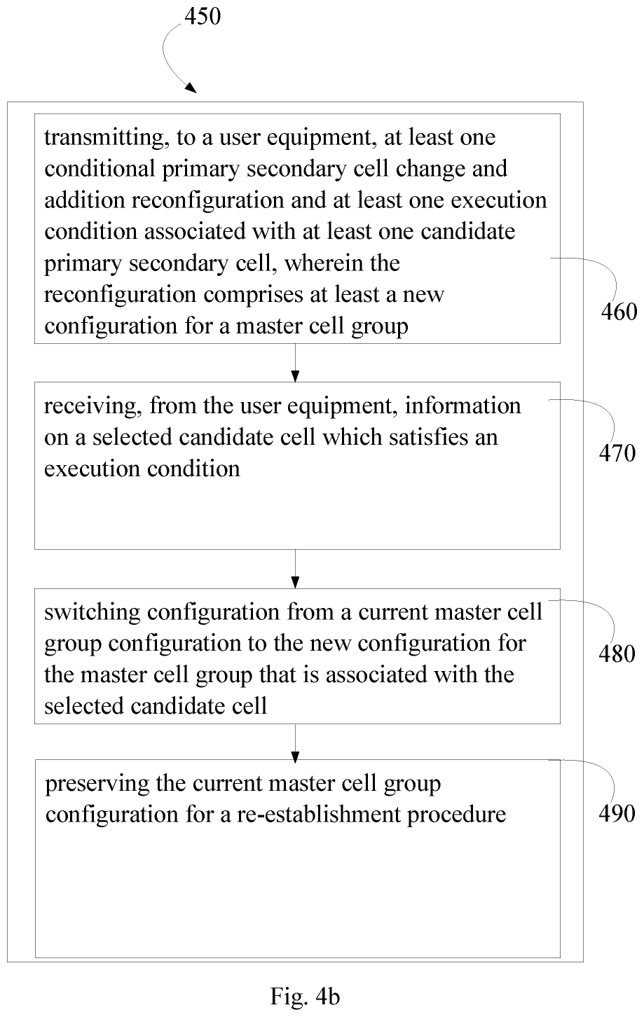

FIG. 4a shows, by way of example, a flowchart of a method 400. The method may be performed by a network node, e.g., a MN. The method 400 comprises transmitting 410, to a user equipment, at least one conditional primary secondary cell change and addition reconfiguration and at least one execution condition associated with at least one candidate primary secondary cell, wherein the reconfiguration comprises at least a new configuration for a master cell group. The method 400 comprises receiving 420, from the user equipment, information on a selected candidate cell which satisfies an execution condition. The method 400 comprises switching 430 configuration from a current master cell group configuration to the new configuration for the master cell group that is associated with the selected candidate cell. The method 400 comprises receiving 440, from the user equipment, a message to trigger a re-establishment procedure, wherein the message comprises an explicit or implicit indication about the conditional primary secondary cell change and addition reconfiguration failure.

FIG. 4b shows, by way of example, a flowchart of a method 450. The method 450 may be performed by a network node, e.g. a MN. The method 450 comprises transmitting 460, to a user equipment, at least one conditional primary secondary cell change and addition reconfiguration and at least one execution condition associated with at least one candidate primary secondary cell, wherein the reconfiguration comprises at least a new configuration for a master cell group. The method 450 comprises receiving 470, from the user equipment, information on a selected candidate cell which satisfies an execution condition. The method 450 comprises switching 480 configuration from a current master cell group configuration to the new configuration for the master cell group that is associated with the selected candidate cell. The method 450 comprises preserving 490 the current master cell group configuration for a re-establishment procedure.

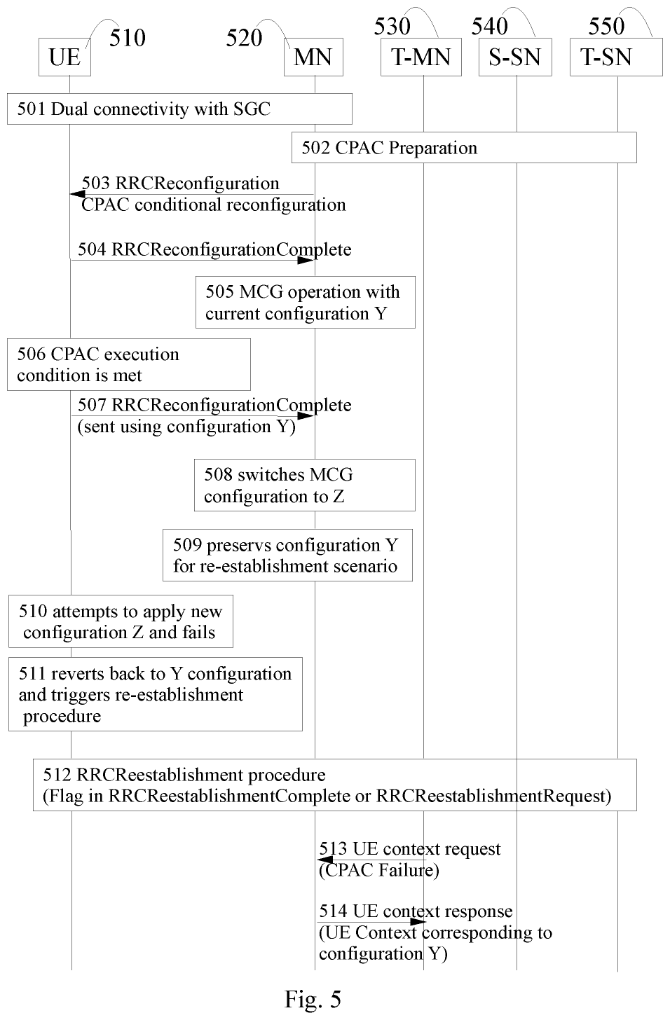

FIG. 5 shows, by way of example, signalling between entities. The UE 510 and the MN 520 support 501 dual connectivity with SCG. The MN 520 and the target MN 530 (T-MN), source SN 540 (S-SN) and target SN 550 (T-SN) have prepared 502 for CPAC. The CPAC may be initiated by MN or SN.

The UE 510 receives from the network node, e.g., the MN, at least one CPAC reconfiguration 503, e.g., as a RRC Reconfiguration message. The message comprises, for example, at least one execution condition associated with at least one PSCell. The reconfiguration comprises at least a new configuration for a MCG, e.g., configuration Z. The reconfiguration may comprise, for example, MCG configuration and SCG configuration. In addition, the message may comprise measurement ID for CPAC execution. The execution condition may be defined such that the candidate PSCell should fulfil some condition related to measurements. The measurements comprise, for example, measurements related to the signal quality of the target cells such as RSRP (reference signal received power).

For example, CPAC reconfiguration may have an ID and comprise an MCG configuration and SCG configuration. The CPAC reconfiguration may be given for each prepared PSCell and the MCG configuration may be different for different candidate prepared PSCell.

The UE 510 may reply to the MN 520 with NR RRC response message (RRCReconfigurationComplete**) 504.

The MN 520 may perform 505 the MCG operation with current MCG configuration, e.g., MCG configuration Y.

The UE 510 evaluates the at least one execution condition. For example, the UE may perform configured measurements according to the measurement ID.

The UE 510 determines 506 that CPAC execution condition is met, that is, an execution condition associated with one of the at least one PSCell is satisfied. The one PScell, i.e the cell the conditions of which have been satisfied, is selected as a selected candidate cell.

The UE 510 transmits 507 information on the selected candidate cell to the MN 520 using the current MCG configuration, e.g., MCG configuration Y. Information on the selected candidate cell may comprise, for example, ID of the CPAC configuration that is applied or will be applied.

For example, the UE may notify the MN that execution condition have been fulfilled for CPAC before transmitting RRCReconfigurationComplete with new MCG configuration. This requires the UE to send an additional signalling message to notify the network about the CPAC triggering, prior to actual execution of the CPAC configuration.

As another example, the UE may transmit RRCReconfigurationComplete upon CPAC execution including an embedded RRCReconfigurationComplete with newly applied configuration. RRCReconfigurationComplete is sent using old/current configuration internally comprising another RRCReconfigurationComplete message, which is generated using new configuration. This message may be sent before actual execution and no further message is sent on actual execution of CPAC configuration.

The MN 520 switches 508 from the current MCG configuration Y to the new configuration for the MCG, wherein the new configuration Z is associated with the selected candidate cell.

For example, the MN 520 may preserve 509 the current, or old, MCG configuration Y for a re-establishment procedure.

The UE 510 may fail to apply the CPAC associated with the selected candidate cell. Thus, the UE 510 may detect a reconfiguration failure. For example, the UE 510 may attempt 510 to apply the new MCG configuration Z or a new SCG configuration and fail in the attempt.

The UE 510 may revert 511 back to Y configuration and trigger a re-establishment procedure.

The UE 510 transmits 512 a message to trigger a re-establishment procedure. A request for re-establishment may be received by a plurality of nodes 520, 530, 540, 550. The message may comprise an explicit or implicit indication about the CPAC reconfiguration failure. The message may be transmitted using the current MCG configuration Y. For example, the message may comprise a request for full configuration. As another example, the message may comprise a reason for the re-establishment. The reason for the re-establishment may be the CPAC failure or the CPAC procedure, for example. Then, the target node that receives the re-establishment request interprets the reason for the re-establishment so that the UE prefers full configuration, and may then reconfigure the UE using full configuration.

Instead of full configuration, the target node may reconfigure the UE using delta configuration, if MN has provided a correct UE context corresponding to the prior configuration Y, as described later below. RRC Reconfiguration message by default provides modification to the configuration with reference to current configuration. The UE may modify the parameters to current configuration according to the received configuration, while other parameters are not modified. This is referred to as delta configuration. In full configuration, network will configure all parameters via RRC Reconfiguration, for example, in case the UE cannot store current configuration, or if there is a problem with the current configuration.

Thus, to prevent the mismatch between the configurations, the UE 510 indicates to the target node receiving the re-establishment request that a full configuration is preferred. If the selected candidate cell is different than the current serving cell, the UE may include an additional parameter, or flag, in RRC re-establishment complete message that full configuration is preferred. This parameter, or flag, may alternatively be included to the RRC re-establishment request message.

In case the MN 520 has preserved 509 the current, or old, or original MCG configuration Y in the UE context, the MN may use this older context in case the MN receives RRC re-establishment request from a cell that it controls for the same UE. This prevents the mismatch between the configurations. If the UE re-establishes the connection in new cell at different node, MN 520 will receive a request 513 from the target node 530 to provide UE context of the UE which is performing re-establishment. In this case, MN 520 can decide to send the UE context response 514 corresponding to the current configuration Y, i.e., before applying the one corresponding to CPAC execution. The decision can be taken by MN to preserve the current configuration in case MN has received the indication from the UE that the CPAC condition is met.

Using the fetched UE context, target MN 530 may decide to apply full configuration or delta configuration based on received configuration for the RRC-Reconfiguration procedure, which is meant to activate the complete configuration for the UE after RRC Re-establishment procedure.

In one embodiment, the target node 530, to which the UE re-establishes to, includes an additional parameter or flag indicating CPAC reconfiguration failure in the UE context request message 513 that is sent to the source node, i.e., MN 520. In response to detecting the indication of CPAC reconfiguration failure, the MN 520 knows to include the current configuration Y in UE context response 514 that is sent back to the target node 530.

The MN 520 may release the old context when it receives any control plane message associated with the new cell.

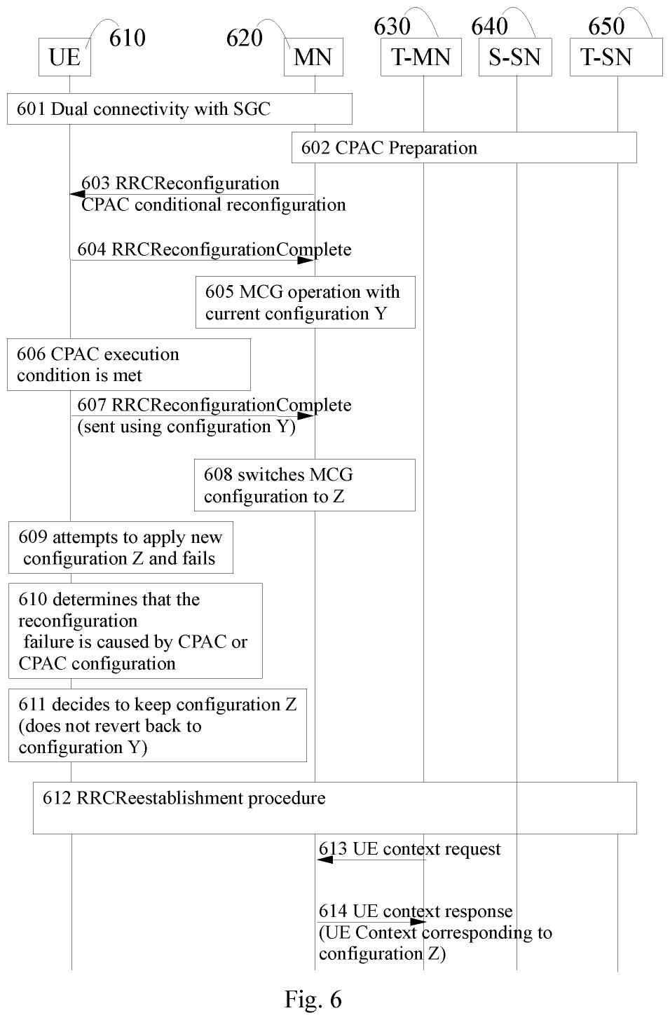

FIG. 6 shows, by way of example, signalling between entities. The UE 610 and the MN 620 support 601 dual connectivity with SCG. The MN 620 and the target MN 630 (T-MN), source SN 640 (S-SN) and target SN 650 (T-SN) have prepared 602 for CPAC. The CPAC may be initiated by MN or SN.

The steps 603 to 608 correspond to the steps 503 to 508 described in the context of FIG. 5.

The UE 610 may fail to apply the CPAC associated with the selected candidate cell. Thus, the UE 610 may detect a reconfiguration failure. For example, the UE 610 may attempt 609 to apply the new MCG configuration Z or a new SCG configuration and fail in the attempt.

Instead of reverting back to the original configuration Y, the UE 610 may determine 610 that the reconfiguration failure is caused by CPAC configuration or CPAC procedure and may decide 611 to keep the configuration Z and use this new configuration for transmitting the message to trigger the re-establishment procedure. In other words, the UE may decide to revert back to the original configuration Y if, e.g., only if, the reconfiguration failure is not caused by executing CPAC configuration after indicating the CPAC execution to the MN. This way, both the UE and the MN will have the latest applied configuration, and the MN includes the new configuration Z to the UE context response. Then, the new target node may reconfigure the UE based on the new configuration.

The UE 610 transmits 612 a message to trigger a re-establishment procedure. A request for re-establishment may be received by a plurality of nodes 620, 630, 640, 650. The message may be transmitted using the new MCG configuration Z.

The MN 620 may receive from a target node 630 a UE context request 613. The MN 620 may then respond to the request via UE context response 614 comprising UE context corresponding to the new configuration Z.

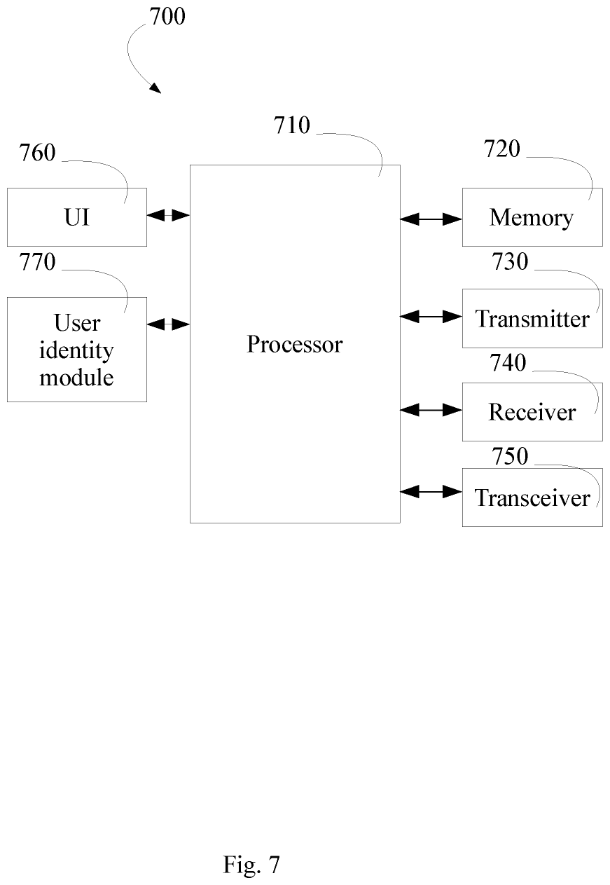

FIG. 7 shows, by way of example, an apparatus capable of performing the methods as disclosed herein. Illustrated is device 700, which may comprise, for example, a mobile communication device such as UE 510, 610 of FIG. 5 or FIG. 6 or a network node such as a MN 520, 620 or T-MN 530, 630 of FIG. 5 or FIG. 6. Comprised in device 700 is processor 710, which may comprise, for example, a single- or multi-core processor wherein a single-core processor comprises one processing core and a multi-core processor comprises more than one processing core. Processor 710 may comprise, in general, a control device. Processor 710 may comprise more than one processor. Processor 710 may be a control device. A processing core may comprise, for example, a Cortex-A8 processing core manufactured by ARM Holdings or a Steamroller processing core designed by Advanced Micro Devices Corporation. Processor 710 may comprise at least one Qualcomm Snapdragon and/or Intel Atom processor. Processor 710 may comprise at least one application-specific integrated circuit, ASIC. Processor 710 may comprise at least one field-programmable gate array, FPGA. Processor 710 may be means for performing method steps in device 700. Processor 710 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 700 may comprise memory 720. Memory 720 may comprise random-access memory and/or permanent memory. Memory 720 may comprise at least one RAM chip. Memory 720 may comprise solid-state, magnetic, optical and/or holographic memory, for example. Memory 720 may be at least in part accessible to processor 710. Memory 720 may be at least in part comprised in processor 710. Memory 720 may be means for storing information. Memory 720 may comprise computer instructions that processor 710 is configured to execute. When computer instructions configured to cause processor 710 to perform certain actions are stored in memory 720, and device 700 overall is configured to run under the direction of processor 710 using computer instructions from memory 720, processor 710 and/or its at least one processing core may be considered to be configured to perform said certain actions. Memory 720 may be at least in part external to device 700 but accessible to device 700.

Device 700 may comprise a transmitter 730. Device 700 may comprise a receiver 740. Transmitter 730 and receiver 740 may be configured to transmit and receive, respectively, information in accordance with at least one cellular or non-cellular standard. Transmitter 730 may comprise more than one transmitter. Receiver 740 may comprise more than one receiver. Transmitter 730 and/or receiver 740 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 700 may comprise a near-field communication, NFC, transceiver 750. NFC transceiver 750 may support at least one NFC technology, such as NFC, Bluetooth, Wibree or similar technologies.

Device 700 may comprise user interface, UI, 760. UI 760 may comprise at least one of a display, a keyboard, a touchscreen, a vibrator arranged to signal to a user by causing device 700 to vibrate, a speaker and a microphone. A user may be able to operate device 700 via UI 760, for example to accept incoming telephone calls, to originate telephone calls or video calls, to browse the Internet, to manage digital files stored in memory 720 or on a cloud accessible via transmitter 730 and receiver 740, or via NFC transceiver 750, and/or to play games.

Device 700 may comprise or be arranged to accept a user identity module 770. User identity module 770 may comprise, for example, a subscriber identity module, SIM, card installable in device 700. A user identity module 770 may comprise information identifying a subscription of a user of device 700. A user identity module 770 may comprise cryptographic information usable to verify the identity of a user of device 700 and/or to facilitate encryption of communicated information and billing of the user of device 700 for communication effected via device 700.

Processor 710 may be furnished with a transmitter arranged to output information from processor 710, via electrical leads internal to device 700, to other devices comprised in device 700. Such a transmitter may comprise a serial bus transmitter arranged to, for example, output information via at least one electrical lead to memory 720 for storage therein. Alternatively to a serial bus, the transmitter may comprise a parallel bus transmitter. Likewise, processor 710 may comprise a receiver arranged to receive information in processor 710, via electrical leads internal to device 700, from other devices comprised in device 700. Such a receiver may comprise a serial bus receiver arranged to, for example, receive information via at least one electrical lead from receiver 740 for processing in processor 710. Alternatively to a serial bus, the receiver may comprise a parallel bus receiver.

Processor 710, memory 720, transmitter 730, receiver 740, NFC transceiver 750, UI 760 and/or user identity module 770 may be interconnected by electrical leads internal to device 700 in a multitude of different ways. For example, each of the aforementioned devices may be separately connected to a master bus internal to device 700, to allow for the devices to exchange information. However, as the skilled person will appreciate, this is only one example and depending on the embodiment various ways of interconnecting at least two of the aforementioned devices may be selected.

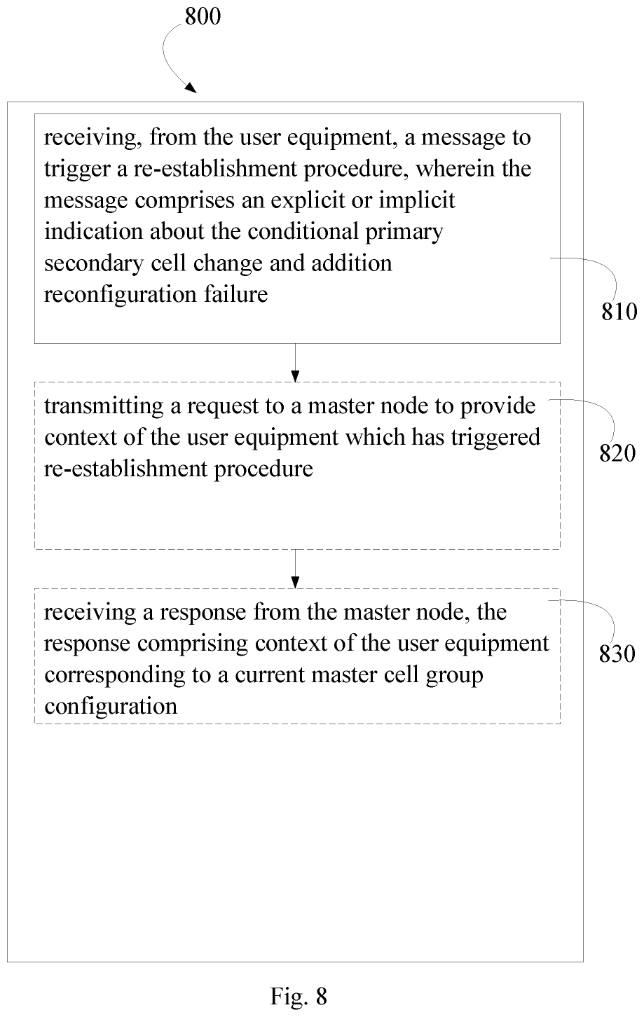

FIG. 8 shows, by way of example, a flowchart of a method 800. The method may be performed by a network node, e.g., T-MN of FIG. 5, configured to function as a target node in a conditional primary secondary cell change and addition procedure. The method comprises receiving 810, from the user equipment, a message to trigger a re-establishment procedure, wherein the message comprises an explicit or implicit indication about the conditional primary secondary cell change and addition reconfiguration failure. The method may comprise transmitting 820 a request to a master node to provide context of the user equipment which has triggered re-establishment procedure. The method may comprise receiving 830 a response from the master node, the response comprising context of the user equipment corresponding to a current master cell group configuration.

1. An apparatus comprising:
at least one processor; and
at least one memory including computer program code;
the at least one memory and the computer program code configured to, with the at least one processor, cause the apparatus at least to:
receive, from a network node, at least one conditional primary secondary cell change and addition reconfiguration and at least one execution condition associated with at least one candidate primary secondary cell, wherein the reconfiguration comprises at least a new configuration for a master cell group;
evaluate the at least one execution condition;
determine that an execution condition associated with one of the at least one candidate primary secondary cell is satisfied;
select the one of the at least one candidate primary secondary cell as a selected candidate cell;
transmit information on the selected candidate cell to the network node using a current master cell group configuration;
fail to apply the conditional primary secondary cell change and addition associated with the selected candidate cell and detecting a reconfiguration failure; and
transmit a message to trigger a re-establishment procedure, wherein the message comprises an explicit or implicit indication about the conditional primary secondary cell change and addition reconfiguration failure.

2. The apparatus of claim 1, wherein the indication comprises a request for a full configuration.

3. The apparatus of claim 1, wherein the indication comprises a reason for the re-establishment, wherein the reason is the conditional primary secondary cell change and addition reconfiguration failure or the conditional primary secondary cell change and addition procedure.

4. The apparatus of claim 1, wherein the at least one processor and the computer program code are configured to cause the apparatus to:
in response to detecting the reconfiguration failure, use the current master cell group configuration for transmitting the message to trigger the re-establishment procedure.

5. The apparatus of claim 1, wherein the at least one processor and the computer program code are configured to cause the apparatus to:
determine that the reconfiguration failure is caused by conditional primary secondary cell change and addition reconfiguration; and
use the new configuration for the master cell group that is associated with the selected candidate cell for transmitting the message to trigger the re-establishment procedure.

6. The apparatus of claim 1, wherein the selected candidate cell is a different cell than a current serving cell.

7. A network node, comprising:
at least one processor; and
at least one memory including computer program code;
the at least one memory and the computer program code configured to, with the at least one processor, cause the network node at least to:
transmit, to a user equipment, at least one conditional primary secondary cell change and addition reconfiguration and at least one execution condition associated with at least one candidate primary secondary cell, wherein the reconfiguration comprises at least a new configuration for a master cell group;
receive, from the user equipment, information on a selected candidate cell which satisfies an execution condition;
switch configuration from a current master cell group configuration to the new configuration for the master cell group that is associated with the selected candidate cell;
receive, from the user equipment, a message to trigger a re-establishment procedure, wherein the message comprises an explicit or implicit indication about the conditional primary secondary cell change and addition reconfiguration failure.

8. The network node of claim 7, wherein the indication comprises a request for a full configuration for the user equipment.

9. The network node of claim 7, wherein the indication comprises a reason for the re-establishment, wherein the reason is the conditional primary secondary cell change and addition reconfiguration failure or the conditional primary secondary cell change and addition procedure.

10. A network node, comprising:
at least one processor; and
at least one memory including computer program code;
the at least one memory and the computer program code configured to, with the at least one processor, cause the network node at least to:
transmit, to a user equipment, at least one conditional primary secondary cell change and addition reconfiguration and at least one execution condition associated with at least one candidate primary secondary cell, wherein the reconfiguration comprises at least a new configuration for a master cell group;
receive, from the user equipment, information on a selected candidate cell which satisfies an execution condition;
switch configuration from a current master cell group configuration to the new configuration for the master cell group that is associated with the selected candidate cell; and
preserve the current master cell group configuration for a re-establishment procedure.

11. A network node, comprising:
at least one processor; and
at least one memory including computer program code;
the at least one memory and the computer program code configured to, with the at least one processor, cause the network node at least to:
receive a request from a target node to provide context of the user equipment which has triggered re-establishment procedure; and
transmit a response to the target node, the response comprising context of the user equipment corresponding to the current master cell group configuration.

12. The network node of claim 11, wherein the request from the target node comprises an indication of a reconfiguration failure.
